(19) United States
(12) Patent Application Publication
(10) Pub. No.: US 2025/0135667 A1
(43) Pub. Date: May 1, 2025

(54) ROTATING AN EXTERNAL CUTTING MEMBER OF A SHAVING UNIT

(71) Applicant: KONINKLIJKE PHILIPS N.V., EINDHOVEN (NL)

(72) Inventor: Hedzer DURKSZ, DE KNIPE (NL)

(21) Appl. No.: 18/715,186

(22) PCT Filed: Dec. 2, 2022
(86) PCT No.: PCT/EP2022/084245

§ 371 Date: May 31, 2024

(30) Foreign Application Priority Data
Dec. 14, 2021 (EP) 21214282.2

(51) Int. Cl. B26B 19/14; B26B 19/28; B26B 19/38

(52) U.S. Cl. CPC B26B 19/145; B26B 19/28; B26B 19/386

(57) ABSTRACT

In a shaving unit for an electric shaver, a hair-cutting unit (30) comprises a housing (40) having a central axis (A_{c}), an external cutting member (31) supported by the housing (40), and an internal cutting member (32) covered by the external cutting member (31). The external cutting member (31) is rotatable about the central axis (A_{c}) relative to the housing (40), and the internal cutting member (32) is rotatable about the central axis (A_{c}) relative to the external cutting member (31). The hair-cutting unit (30) further comprises a transmission unit (60) which is accommodated in the housing (40) and which comprises a first transmission member (61) mounted to the internal cutting member (32), a second transmission member (62) mounted to the external cutting member (31), and at least one intermediate transmission member (63, 64, 65) via which the first transmission member (61) is coupled to the second transmission member (62).

### FIELD OF THE INVENTION

The invention relates to a shaving unit for an electric shaver, comprising a supporting member and at least two hair-cutting units supported by the supporting member, wherein each hair-cutting unit comprises:
a housing having a central axis;
an external cutting member supported by the housing and comprising an annular shaving area having a plurality of hair-entry openings, the external cutting member being rotatable about the central axis relative to the housing; and
an internal cutting member which is covered by the external cutting member and rotatable about the central axis relative to the external cutting member and has a coupling member;
wherein the shaving unit comprises, for each hair-cutting unit, an individual drive shaft which is releasably coupled to the coupling member of the internal cutting member for rotating the internal cutting member about the central axis relative to the external cutting member.

Further, the invention relates to an electric shaver comprising:
a main body accommodating a motor; and
a shaving unit as described here before, wherein the supporting member of the shaving unit is coupled to the main body.

### BACKGROUND OF THE INVENTION

Electric shavers and shaving units for electric shavers are well known. Electric shavers are generally used to shave body hair, which may be facial hair, and are powered by electric supply mains and/or by electric energy storage devices such as batteries.

In a generally known set-up, a shaving unit comprises an assembly of a supporting member and at least two hair-cutting units supported by the supporting member. Traditionally, the hair-cutting units each comprise a combination of an external cutting member having a shaving area provided with hair-entry openings as a non-driven component and an internal cutting member as a driven component, wherein at least the internal cutting member has one or more cutting edges. In such a case, use of the shaving unit as incorporated in an electric shaver involves putting the shaving unit to an operation mode in which the internal cutting members of the hair-cutting units are actually moved, and moving the shaving unit over the skin in such a way that the shaving areas of the external cutting members of the hair-cutting units face and contact the skin. In the process, hairs protruding from the skin are caught in a space of a housing of the hair-cutting units in which they are made to abut against the external cutting member at the position of a hair-entry opening and are cut through when they are encountered by a cutting edge of the internal cutting member.

For the type of shaving unit comprising the above-mentioned combination of an external cutting member and an internal cutting member in each of the at least two hair-cutting units thereof, it has been proposed to also rotate the external cutting members relative to the surrounding stationary parts of the shaving unit. This may increase the hair-catching ability of the at least two hair-cutting units, because the skin is enabled to encounter more open areas of the external cutting members, i.e. more hair-entry openings. Known measures aimed at realizing good hair-catching ability of the at least two hair-cutting units rely on stimulating user behavior, especially behavior which involves moving the shaving unit over the skin in circles. However, it appears that users often do not perform the circular movement in a correct manner or even do not perform the circular movement at all. It is therefore desirable to make a structural adjustment to the shaving unit rather than trying to let the user take certain actions, and having rotating external cutting members is exactly such an adjustment. However, the presence of required additional driving components may lead to increased bulkiness of the at least two hair-cutting units, and may also reduce any skin contour following ability of the at least two hair-cutting units.

CH 376 798 A discloses an electric shaver having a single hair-cutting unit. The hair-cutting unit has an external foil-type cutting member which is rotatably arranged on a main housing of the shaver by means of a ball bearing, so that the external cutting member is rotatable about a central axis of the hair-cutting unit. The hair-cutting unit further has an internal cutting member which is mounted on a drive shaft driven by a motor, so that the internal cutting member is rotatable by the motor about the central axis. The motor can also rotate the external cutting member about the central axis at a relatively low speed via a transmission mechanism arranged between the drive shaft and the external cutting member. The transmission mechanism comprises a first gear wheel mounted to the drive shaft, a second gear wheel mounted in a stationary position to an inner surface of the main housing, a third gear wheel mounted in a stationary position to an inner surface of the external cutting member, and a pair of diametrically oppositely arranged intermediate gear wheels that each engage with both the first, second and third gear wheels.

It is an object of the invention to provide a shaving unit in which the at least two hair-cutting units each comprise a rotatable external cutting member, yet which does not have the above-mentioned disadvantages, especially the disadvantages of increased bulkiness and reduced skin contour following ability of the at least two hair-cutting units.

### SUMMARY OF THE INVENTION

The invention provides a shaving unit for an electric shaver, comprising a supporting member and at least two hair-cutting units supported by the supporting member, wherein each hair-cutting unit comprises:
a housing having a central axis;
an external cutting member supported by the housing and comprising an annular shaving area having a plurality of hair-entry openings, the external cutting member being rotatable about the central axis relative to the housing; and
an internal cutting member which is covered by the external cutting member and rotatable about the central axis relative to the external cutting member and has a coupling member;
wherein the shaving unit comprises, for each hair-cutting unit, an individual drive shaft which is releasably coupled to the coupling member of the internal cutting member for rotating the internal cutting member about the central axis relative to the external cutting member; and
   wherein each hair-cutting unit comprises a transmission unit by means of which the external cutting member is rotatable about the central axis relative to the housing, the transmission unit being accommodated in the housing of the hair-cutting unit and comprising:
a first transmission member mounted to the internal cutting member to be rotatable together with the internal cutting member about the central axis;
a second transmission member mounted to the external cutting member to be rotatable together with the external cutting member about the central axis; and
at least one intermediate transmission member via which the first transmission member is coupled to the second transmission member to convert a rotation of the internal cutting member about the central axis into a rotation of the external cutting member about the central axis.

It follows from the above definition of the shaving unit according to the invention that the shaving unit comprises, for each hair-cutting unit, a separate transmission unit which is used to bring about rotation of the external cutting member of the respective hair-cutting unit, wherein the transmission unit is accommodated in the housing of the respective hair-cutting unit and comprises an assembly of a first transmission member, a second transmission member and at least one intermediate transmission member. The first transmission member is mounted to the internal cutting member of the respective hair-cutting unit and the second transmission member is mounted to the external cutting member of the respective hair-cutting unit. Hence, in each respective hair-cutting unit the transmission unit is configured to bring about movement of the external cutting member on the basis of the movement of the internal cutting member. To put it differently, in each respective hair-cutting unit the external cutting member is powered by the internal cutting member through the transmission unit in the respective hair-cutting unit during operation. This means that no separate drive train is required outside of the hair-cutting units for the purpose of rotating the external cutting members besides the internal cutting members, but that rather the existing drive train for driving the internal cutting members is extended, which provides a possibility of having the rotatable external cutting members as desired without needing to increase dimensions of the shaving unit, at least not to such an extent that a notably more bulky appearance of the shaving unit is obtained. Also, on the basis of the fact that, for each respective hair-cutting unit, the transmission unit is accommodated in the housing of the hair-cutting unit, it is achieved that any skin contour following pivoting motion of the hair-cutting units is not hindered in any way. In particular, the housings of the hair-cutting units, including the transmission units accommodated therein, may be configured to be pivotable relative to the supporting member of the shaving unit, which enables each hair-cutting unit of the shaving unit to individually follow any local skin contours during the shaving process without affecting the rotational driving of the external cutting members of the hair-cutting units.

Having the option of skin contour following is particularly appropriate if the shaving unit comprises at least two hair-cutting units, as without it a user would only be capable to move the at least two hair-cutting units in a certain predetermined structural relation over the skin. In the case that each of the at least two hair-cutting units of the shaving unit is pivotable relative to the supporting member about at least one pivot axis, it is advantageous if the coupling member of the internal cutting member of each hair-cutting unit, by means of which the internal cutting member is releasably coupled to the individual drive shaft associated with the hair-cutting unit, is configured to maintain rotational coupling with the individual drive shaft during pivoting of the hair-cutting unit about the at least one pivot axis. In this way, in the drive train extending from the drive shaft via the transmission unit to the external cutting member, the transmission unit is entirely arranged between the coupling member and the external cutting member, which enables the transmission unit to pivot relative to the individual drive shaft in unity with the internal cutting member and the external cutting member. For example, it may be so that each of the individual drive shafts comprises a coupling head, wherein the coupling member of the internal cutting member of each hair-cutting unit comprises a cavity accommodating the coupling head of the individual drive shaft associated with the hair-cutting unit, and wherein surfaces of the coupling head and the cavity are configured to slide over each other during pivoting of the hair-cutting unit about the at least one pivot axis, which does not alter the fact that the invention covers other options in respect of the way in which pivoting motion of the hair-cutting units is enabled as well.

In view of usual ranges of the speed of rotation of the internal cutting members, to prevent an increase of skin irritation by the rotating external cutting members, it is practical if in the shaving unit according to the invention, the transmission unit of each hair-cutting unit is configured to reduce speed in the direction from the internal cutting member to the external cutting member, in other words, the transmission unit is configured to convert a rotation of the internal cutting member about the central axis at a first rotational speed into a rotation of the external cutting member about the central axis at a second rotational speed, wherein the second rotational speed is lower than the first rotational speed. For example, it may be practical if the speed reduction rate of the transmission unit is such that the external cutting member is made to run at a rotational speed in a range of about 40 rpm to 120 rpm during normal operation of the shaving unit, while the rotational speed of the internal cutting member may be as high as a speed in a range of about 2,000 rpm to 2,500 rpm.

It appears from consumer tests that when a shaving unit comprising hair-cutting units in which the external cutting member is rotated at a speed in a range of about 40 rpm to 120 rpm during operation is used on the skin to subject the skin to a shaving action, the average user perceives the shaving action as comfortable. At the same time, as an advantageous result of rotating the external cutting member, the hair-catching efficiency of the hair-cutting units is less dependent on the way in which the user moves the shaving unit over the skin, in particular in areas where it is difficult to realize the recommended circular movement of the shaving unit over the skin.

In a practical embodiment of the shaving unit according to the invention, the transmission unit comprises an arrangement of meshing gear wheels. In this respect, it may particularly be so that in the transmission unit:
the first transmission member comprises a first gear wheel arranged on the coupling member of the internal cutting member co-axially relative to the central axis;
the second transmission member comprises a second gear wheel arranged on an inner side of an annular flange portion of the external cutting member and co-axially relative to the central axis; and
the at least one intermediate transmission member comprises at least one intermediate gear wheel via which the first gear wheel is coupled to the second gear wheel, each intermediate gear wheel having its rotational bearing arranged on the housing.

Arranging the second gear wheel on an inner side of an annular flange portion of the external cutting member offers many possibilities of realizing a compact design of the transmission unit. The annular flange portion is part of the usual cup-shaped design of the external cutting member, and the dimensions and other properties of said flange portion may be easily adapted to better fit to the second gear wheel.

Further advantageous options existing in the context of the invention and enabling compactness of design of the transmission unit include 1) in case the transmission unit comprises at least two intermediate gear wheels, including the rotational bearings of the respective intermediate gear wheels in an integral housing part, and 2) designing the at least one intermediate transmission member so as to comprise a pair of intermediate gear wheels in stacked configuration.

A practical example of an alternative for the gear wheels is a belt drive. In such a case, the first and second transmission members may be designed as wheels for engaging the belt of the belt drive, the belt constituting the intermediate transmission member of the transmission unit. Further, it is possible that transmission unit comprises friction wheels, in which case damage as a result of high loads on the hair-cutting unit may be prevented on the basis of slip of the friction wheels.

In respect of the housing of each hair-cutting unit, it is noted that a well-known practical option is applicable in the context of the invention as well, namely the option of the housing comprising a skin-contacting surface which surrounds the external cutting member of the hair-cutting unit.

As mentioned earlier, the invention also relates to an electric shaver comprising:
a main body accommodating a motor; and
a shaving unit as described here before, wherein the supporting member of the shaving unit is coupled to the main body.

In the context of the electric shaver according to the invention, it may particularly be practical if the supporting member of the shaving unit comprises a connecting member by means of which the shaving unit is releasably connected to the main body. Further, it is possible for said connecting member to accommodate a main drive shaft which is coupled to the motor in a connected condition of the shaving unit to the main body, and for the shaving unit to comprise a transmission system to convert rotation of the main drive shaft into rotation of the individual drive shaft of each hair-cutting unit of the shaving unit. In such a case, the main drive shaft may be arranged so as to extend at a position at which the longitudinal axis thereof coincides with the central axis of the housing of the shaving unit, but this is not necessary in the context of the invention.

The above-described and other aspects of the invention will be apparent from and elucidated with reference to the following detailed description of a practical embodiment of a shaving unit comprising three hair-cutting units, wherein each hair-cutting unit comprises a housing, an external cutting member which is rotatable relative to the housing, a rotatable internal cutting member which is also rotatable relative to the housing, and a transmission unit for transmitting rotating motion from the internal cutting member to the external cutting member.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of an electric shaver comprising a shaving unit according to an embodiment of the invention and a main body;

FIG. 2 diagrammatically shows a sectional view of a hair-cutting unit of the shaving unit;

FIG. 3 diagrammatically shows another sectional view of a hair-cutting unit and illustrates how the hair-cutting unit is arranged in the larger entity of the shaving unit;

FIGS. 4 and 5 both show a perspective bottom view of the hair-cutting unit, wherein a housing part shown in FIG. 4 is omitted in FIG. 5; and

FIG. 6 illustrates the configuration of a transmission unit of the hair-cutting unit.

### DETAILED DESCRIPTION OF THE EMBODIMENTS

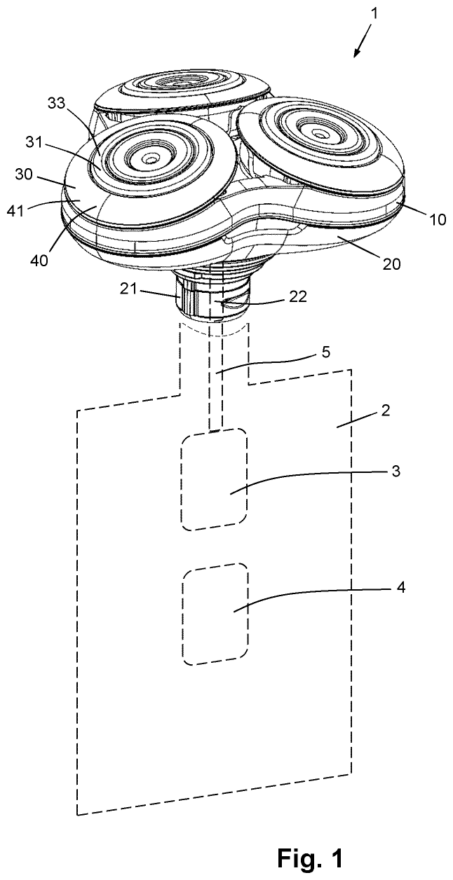

The invention relates to a shaving unit 10 configured to be used in an electric shaver 1. With reference to FIG. 1, it is noted that the shaving unit 10 comprises a supporting member 20 and three hair-cutting units 30 supported by the supporting member 20. In the context of the invention, the number of hair-cutting units 30 can be chosen freely and does not necessarily need to be three, the number being at least two.

FIG. 1 illustrates how the shaving unit 10 is combined with a main body 2 in an electric shaver 1, the supporting member 20 of the shaving unit 10 being coupled to the main body 2. The main body 2 can be of any suitable design and is only diagrammatically shown by means of dashed lines. The electric shaver 1 is a handheld device, and for the purpose of performing a shaving action on skin by means of the shaver 1, a user of the shaver 1 is supposed to take hold of the main body 2, to place the shaving unit 10 on the skin and to move the shaving unit 10 over the skin. The electric shaver 1 is shown in a normal orientation, which is an orientation in which the shaving unit 10 is positioned on top of the main body 2, and it is this orientation that is at the basis of terms as used in the present text for indicating positioning of components. Still, it is to be noted that the definitions of the shaving unit 10 and the electric shaver 1 in the attached claims are not restricted to this orientation, that is to say, the definitions are applicable to the shaving unit 10 and the shaver 1 in any possible orientation.

The shaving unit 10 constitutes the part of the electric shaver 1 by means of which the action of cutting off hairs from the skin can actually be performed, while the main housing 2 may have a function in accommodating a motor 3 for driving the components of the shaving unit 10 involved in such action. The main housing 2 may further include means such as a rechargeable battery 4 for powering the motor 3.

It is practical if the shaving unit 10 and the main housing 2 are releasably connectable to each other, as known per se in the field of electric shavers, and if the supporting member 20 of the shaving unit 10 comprises a connecting member 21 accommodating a main drive shaft 22 which is coupled to the motor 3 in a connected condition of the shaving unit 10 to the main body 2. This option is illustrated in FIG. 1, wherein both the main drive shaft 22 and an output shaft 5 of the motor 3 are indicated through dashed lines.

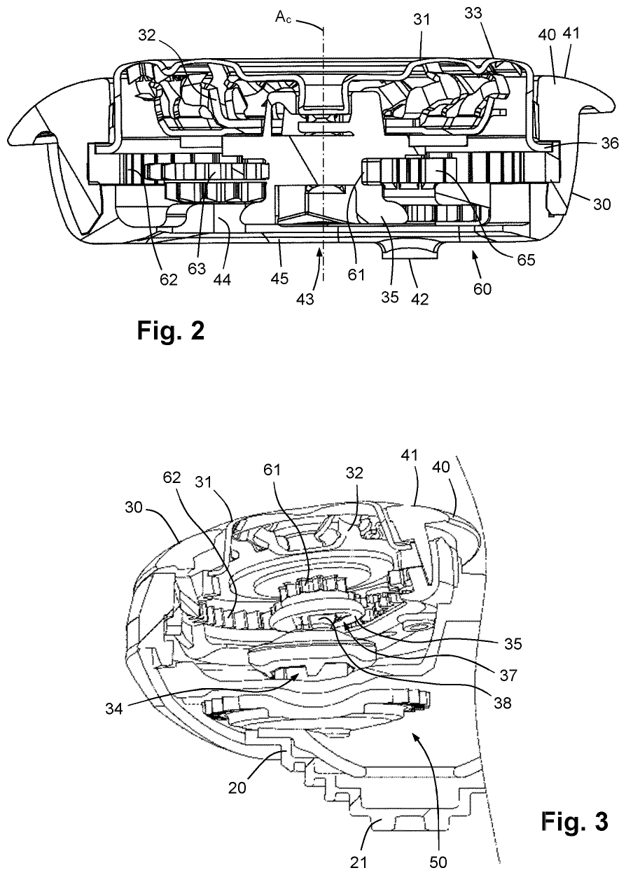

In the following, a further explanation of the set-up of a hair-cutting unit 30 of the shaving unit 10 is provided. As can be seen in the sectional view shown in FIG. 2, the hair-cutting unit 30 comprises a housing 40 having a central axis A_{c}, an external cutting member 31 supported by the housing 40 and surrounded by a skin-contacting surface 41 of the housing 40, and an internal cutting member 32 which is covered by the external cutting member 31. The external cutting member 31 comprises an annular shaving area 33 having a plurality of hair-entry openings. For the sake of clarity, it is noted that the hair-entry openings are not shown in the figures. The internal cutting member 32 is rotatable about the central axis A_{c} relative to the external cutting member 31. When the electric shaver 1 is operated to perform a shaving action and both the skin-contacting surface 41 of the housing 40 and the shaving area 33 of the external cutting member 31 contact the skin, hairs which get caught in the hair-entry openings of the shaving area 33 of the external cutting member 31 as the shaving unit 10 is moved over the skin are cut off by means of the internal cutting member 32 which is driven so as to perform the rotating movement relative to the external cutting member 31 during operation. In this respect, it is noted that the shaving unit 10 comprises an individual drive shaft 34 for each hair-cutting unit 30, and that in each of the hair-cutting units 30, the individual drive shaft 34 is releasably coupled to the internal cutting member 32 by means of a coupling member 35 of the internal cutting member 32. The shaving unit 10 further comprises a transmission system 50 to convert rotation of the main drive shaft 22 into rotation of the individual drive shaft 34 of each hair-cutting unit 30 of the shaving unit 10. Such a transmission system 50 may comprise a number of gear wheels, for example, wherein it is noted that one of such gear wheels is shown in FIG. 3.

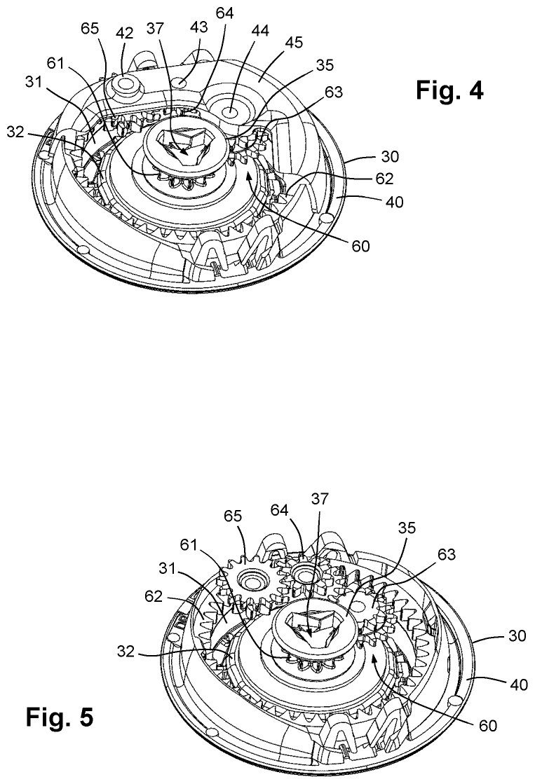

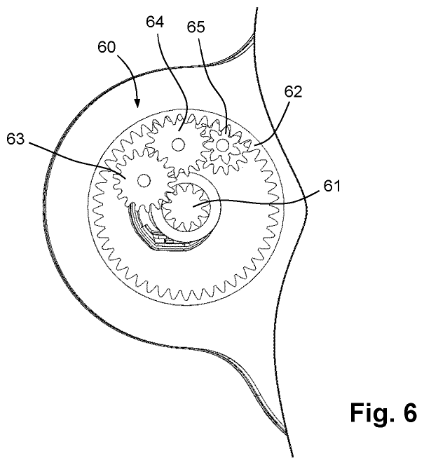

A notable aspect of the shaving unit 10 resides in the fact that the external cutting member 31 is rotatable about the central axis A_{c} relative to the housing 40, and that the hair-cutting unit 30 comprises a transmission unit 60 by means of which this feature of the external cutting member 31 is actually realized. As can be seen best in FIGS. 4, 5 and 6, the transmission unit 60 is accommodated in the housing 40 of the hair-cutting unit 30 and comprises:
a first transmission member 61 mounted to the internal cutting member 32 to be rotatable together with the internal cutting member 32 about the central axis A_{c};
a second transmission member 62 mounted to the external cutting member 31 to be rotatable together with the external cutting member 31 about the central axis A_{c}; and
three intermediate transmission members 63, 64, 65 via which the first transmission member 61 is coupled to the second transmission member 62 to convert a rotation of the internal cutting member 32 about the central axis A_{c} into a rotation of the external cutting member 31 about the central axis A_{c}.

On the basis of this configuration, it is achieved that, when the internal cutting member 32 is driven to rotate, all of the transmission members 61, 62, 63, 64, 65 are rotated as well, as a result of which the rotational movement of the internal cutting member 32 brings about rotational movement of the external cutting member 31.

In the context of the invention, the number of intermediate transmission members 63, 64, 65 can be chosen freely and does not necessarily need to be three, the number being at least one. In the present embodiment, the intermediate transmission members 63, 64, 65 are positioned below the internal cutting member 32. Further, in the present embodiment, the first transmission member 61 comprises a first gear wheel arranged on the coupling member 35 of the internal cutting member 32 co-axially relative to the central axis A_{c}, the second transmission member 62 comprises a second gear wheel arranged on an inner side of an annular flange portion 36 of the external cutting member 31 and co-axially relative to the central axis A_{c}, and the intermediate transmission members 63, 64, 65 comprise intermediate gear wheels via which the first gear wheel is coupled to the second gear wheel. In particular, in the present embodiment, each intermediate transmission member 63, 64, 65 comprises a pair of gear wheels in stacked configuration. As can be seen best in FIG. 4, rotational bearings 42, 43, 44 of the respective intermediate transmission members 63, 64, 65 are included in an integral housing part 45, and the transmission members 63, 64, 65 are mounted to the housing part 45 by being rotatably arranged on the rotational bearings 42, 43, 44, while the position of the transmission members 63, 64, 65 in the direction of the central axis A_{c} is fixed.

It is practical if the external cutting member 31 is rotated at a considerably lower speed than the internal cutting member 32 during operation, so that it is possible to realize an effective hair-cutting process at a high level of comfort. In view thereof, it is practical if the transmission unit 60 is designed so as to reduce rotational speed in the direction from the internal cutting member 32 to the external cutting member 31. For example, the speed reduction rate may be in a range of about 20 to 25 in order to set a rotational speed of 100 rpm of the external cutting member 31 at a usual value of the rotational speed of the internal cutting member 32.

In the present embodiment, in order to realize skin contour following by the hair-cutting units 30, each hair-cutting unit 30 is pivotably arranged in the supporting member 20. It is the coupling member 35 of the internal cutting member 32 which is configured to maintain the rotational coupling of the internal cutting member 32 to the individual drive shaft 34 in each possible pivoted position of the hair-cutting unit 30 relative to the supporting member 20. To that end, the coupling member 35 comprises a cavity 37 accommodating a coupling head 38 of the individual drive shaft 34, wherein the shape and dimension of the coupling head 38 and the cavity 37 relative to each other are chosen such that surfaces of the coupling head 38 and the cavity 37 are configured to slide over each other during pivoting of the hair-cutting unit 30 relative to the supporting member 20. On the basis of their arrangement on the internal cutting member 31, the external cutting member 32, and the housing 40, respectively, the respective transmission members 61, 62, 63, 64, 65 of the transmission unit 60 are not in the way of any other component of the hair-cutting unit 30 during pivoting, so that the functionality of rotating the external cutting member 31 relative to the housing 40 does not compromise the skin contour following ability of the hair-cutting unit 30. Furthermore, the coupling member 35 provides a releasable coupling between the internal cutting member 31 and the individual drive shaft 34 in that the coupling head 38 of the individual drive shaft 34 can be moved out of the cavity 37 of the coupling member 35 by moving the coupling member 35 in an axial direction away from the individual drive shaft 34, as is known in the art.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

Notable aspects of the invention are summarized as follows. In a shaving unit 10 for an electric shaver 1, a hair-cutting unit 30 of the shaving unit 10 comprises a housing 40 having a central axis A_{c}, an external cutting member 31 supported by the housing 40, and an internal cutting member 32 covered by the external cutting member 31. The external cutting member 31 is rotatable about the central axis A_{c} relative to the housing 40, and the internal cutting member 32 is rotatable about the central axis A_{c} relative to the external cutting member 31. The hair-cutting unit 30 further comprises a transmission unit 60 which is accommodated in the housing 40 and which comprises a first transmission member 61 mounted to the internal cutting member 32, a second transmission member 62 mounted to the external cutting member 31, and at least one intermediate transmission member 63, 64, 65 via which the first transmission member 61 is coupled to the second transmission member 62 to convert a rotation of the internal cutting member 32 about the central axis A_{c} into a rotation of the external cutting member 31 about the central axis A_{c}.

1. Shaving unit for an electric shaver, comprising a supporting member and at least two hair-cutting units supported by the supporting member, wherein each hair-cutting unit comprises:
a housing having a central axis;
an external cutting member supported by the housing and comprising an annular shaving area having a plurality of hair-entry openings, the external cutting member being rotatable about the central axis relative to the housing; and
an internal cutting member which is covered by the external cutting member and rotatable about the central axis relative to the external cutting member and has a coupling member;
wherein the shaving unit comprises, for each hair-cutting unit, an individual drive shaft which is releasably coupled to the coupling member of the internal cutting member for rotating the internal cutting member about the central axis relative to the external cutting member;
characterized in that each hair-cutting unit comprises a transmission unit by means of which the external cutting member is rotatable about the central axis relative to the housing, the transmission unit being accommodated in the housing of the hair-cutting unit and comprising:
a first transmission member mounted to the internal cutting member to be rotatable together with the internal cutting member about the central axis;
a second transmission member mounted to the external cutting member to be rotatable together with the external cutting member about the central axis; and
at least one intermediate transmission member via which the first transmission member is coupled to the second transmission member to convert a rotation of the internal cutting member about the central axis into a rotation of the external cutting member about the central axis.

2. Shaving unit as claimed in claim 1, wherein:
each hair-cutting unit is pivotable relative to the supporting member about at least one pivot axis; and
the coupling member of the internal cutting member of each hair-cutting unit is configured to maintain rotational coupling with the individual drive shaft associated with the hair-cutting unit during pivoting of the hair-cutting unit about the at least one pivot axis.

3. Shaving unit as claimed in claim 2, wherein each of the individual drive shafts comprises a coupling head, wherein the coupling member of the internal cutting member of each hair-cutting unit comprises a cavity-accommodating the coupling head of the individual drive shaft associated with the hair-cutting unit, and wherein surfaces of the coupling head and the cavity are configured to slide over each other during pivoting of the hair-cutting unit about the at least one pivot axis.

4. Shaving unit as claimed in claim 1, wherein the transmission unit is configured to convert a rotation of the internal cutting member about the central axis at a first rotational speed into a rotation of the external cutting member about the central axis at a second rotational speed, wherein the second rotational speed is lower than the first rotational speed.

5. Shaving unit as claimed in claim 4, wherein the transmission unit is configured to realize a speed reduction rate in a range of about 20 to 25.

6. Shaving unit as claimed in claim 1, wherein the transmission unit is configured to make the external cutting member run at a rotational speed in a range of about 40 rpm to 120 rpm.

7. Shaving unit as claimed in claim 1, wherein in the transmission unit:
the first transmission member comprises a first gear wheel arranged on the coupling member of the internal cutting member co-axially relative to the central axis;
the second transmission member comprises a second gear wheel arranged on an inner side of an annular flange portion of the external cutting member and co-axially relative to the central axis; and
the at least one intermediate transmission member comprises at least one intermediate gear wheel via which the first gear wheel is coupled to the second gear wheel, each intermediate gear wheel having its rotational bearing arranged on the housing.

8. Shaving unit as claimed in claim 7, wherein the transmission unit comprises at least two intermediate gear wheels, and wherein the rotational bearings of the respective intermediate gear wheels are included in an integral housing part.

9. Shaving unit as claimed in claim 7, wherein in the transmission unit, the at least one intermediate transmission member comprises a pair of intermediate gear wheels in stacked configuration.

10. Shaving unit as claimed in claim 1, wherein the housing of each hair-cutting unit comprises a skin-contacting surface which surrounds the external cutting member of the hair-cutting unit.

11. Electric shaver comprising:
a main body accommodating a motor; and
a shaving unit as claimed in claim 1, wherein the supporting member of the shaving unit is coupled to the main body.

12. Electric shaver as claimed in claim 11, wherein:
the supporting member of the shaving unit comprises a connecting member by means of which the shaving unit is releasably connected to the main body;
the connecting member accommodates a main drive shaft which is coupled to the motor in a connected condition of the shaving unit to the main body; and
the shaving unit comprises a transmission system to convert rotation of the main drive shaft into rotation of the individual drive shaft of each hair-cutting unit of the shaving unit.
